(19) United States
(12) Patent Application Publication
(10) Pub. No.: US 2025/0083114 A1
(43) Pub. Date: Mar. 13, 2025

(54) VERTICAL FEED MIXER

(71) Applicant: Vermeer Manufacturing Company, Pella, IA (US)

(72) Inventor: Jared Dolch, Elliott, IA (US)

(21) Appl. No.: 18/824,235

(22) Filed: Sep. 4, 2024

Related U.S. Application Data
(60) Provisional application No. 63/581,532, filed on Sep. 8, 2023.

(51) Int. Cl. B01F 35/75; B01F 27/808; B01F 27/92; B01F 33/502; B01F 35/10; B01F 101/18

(52) U.S. Cl. CPC B01F 35/7541; B01F 27/808; B01F 27/92; B01F 33/5023; B01F 35/10; B01F 35/751; B01F 2101/18

(57) ABSTRACT

A feed mixer for mixing material. The feed mixer includes a tub that defines a tub interior. A rotatable screw assembly is located in the tub interior. A conveyor assembly is pivotably located along an outer surface of the tub at a discharge opening. The screw assembly moves material towards the conveyor assembly as the screw assembly rotates. The conveyor assembly includes a conveyor and a positioning system configured to move the conveyor between a conveying state, a stowed state, and a maintenance state.

### CROSS-REFERENCE TO RELATED APPLICATIONS

This application claims the benefit of U.S. Provisional Patent Application No. 63/581,532, filed Sep. 8, 2023, which is incorporated herein by reference in its entirety.

### FIELD OF THE DISCLOSURE

The field of the disclosure relates to a feed mixer and, more particularly, to a vertical-type feed mixer that includes a conveyor assembly with a positioning system which moves a conveyor between conveying, stowed, and maintenance positions.

### BACKGROUND

Feed mixers are utilized to process bales and other feedstuffs as well as blend in desired nutrient additives or supplements. Vertical mixers typically include a tub, a rotating element with knives or blades, and a conveyor system. In use, a bale of material is dropped into the tub mixing chamber, and the rotating element chops the bale up into smaller pieces of material. As the bale is processed, the additives can be mixed in with the chopped material. Movement of the rotating element urges the mixture of material and additives upwards during processing due to the geometry and direction of the rotation of the rotating element. Eventually, material falls downward to the bottom of the tub and mixing chamber. The rotating element continues to mix the material, and the contents of the tub are continuously stirred by the rotating element, ensuring the ingredients are sufficiently mixed. Once mixing is complete, the feed mixture can be discharged out of the tub by the conveyor system.

Many vertical mixers include a single or twin (dual) screws designed to break the bale of material into smaller pieces and provide adequate blending of the ingredients. Single screw designs are typically reserved for smaller capacity mixers, and twin screw designs are ideal for larger capacity mixers.

Single screw designs have the advantage of more available capacity for a given tub size. However, the single screw design may not suitably reduce the size of the bale and mix the bale with supplemental ingredients as the vertical mixer capacity increases. A single screw may process a bale more slowly than a twin screw design. In addition to the inefficiency of longer bale processing times, the additional time to process a bale may allow for material to fall away from the bale as it is being processed, and potentially fall out of the mixer. In order to retain as much of the material in the mixer, it is ideal to process the bale quickly.

Conveyor systems are used to move the feed mixture out of the tub once mixing is completed. A conveyor may be positioned in any location along the exterior of the tub. In some known designs, the conveyor is located proximate the bottom of the tub along a front side of the mixer and near the hitch of the trailer that supports the mixer. The conveyor may have a first segment that is directed outward from the front of the tub and a second segment directed toward either side of the mixer tub. The second segment forms a 90-degree angle with the first segment. The material is discharged from the tub along the first and second conveyor segments. The 90-degree turn of the conveyor may cause some feed material to become stuck or lodged in the conveyor, blocking the flow of material along the conveyor.

Locating the conveyor along the side of the mixer is less common in known designs. A side mounted conveyor may inhibit access to the frame or wheel assemblies for maintenance. For example, particularly on smaller vertical mixers, a side conveyor may be positioned over the wheel of the frame, making maintenance activities, such as tire changes, difficult to complete. In many of these instances, the tires are required to be smaller. However, smaller tires impact the overall size and the terrain that the mixer can handle. When mixers include smaller tires, they have a smaller tub capacity and are not be able to handle rough or rugged terrains. Because vertical mixers are mostly used in farming and ranching, it is important that the mixers be able to handle the rugged terrain, and therefore, the largest tires possible are preferred.

There is a need for an improved vertical mixer to provide efficient operation in a wide variety of terrains, while providing adequate access for maintenance activities.

### SUMMARY

One aspect of the present disclosure is directed to a feed mixer for mixing material. The feed mixer includes a tub having a bottom and at least one sidewall. The at least one sidewall includes an outer surface and an inner surface. A discharge opening is located in the at least one sidewall. The inner surface and the bottom define a tub interior. A screw assembly is located in the tub interior. The screw assembly is rotatable. A conveyor assembly is pivotably located along the outer surface at the discharge opening. The screw assembly moves material towards the conveyor assembly as the screw assembly rotates. The conveyor assembly includes a conveyor mounting bracket pivotably mounted to the tub and a linkage pivotally mounted to the tub. The conveyor assembly includes a conveyor pivotally mounted to the conveyor mounting bracket and pivotally mounted to the linkage. The conveyor assembly includes an actuator for moving the conveyor between a stowed position and a maintenance position.

Another aspect of the present disclosure is directed to a feed mixer for mixing material. The feed mixer includes a tub having a bottom and at least one sidewall. The at least one sidewall includes an outer surface and an inner surface. A discharge opening is located in the at least one sidewall. The inner surface and the bottom define a tub interior. A screw assembly is located in the tub interior. The screw assembly is rotatable. A conveyor assembly is pivotably located along the outer surface at the discharge opening. The screw assembly moves material towards the conveyor assembly as the screw assembly rotates. The conveyor assembly includes a conveyor and a positioning system configured to rotate the conveyor between a stowed position, a conveying position, and a maintenance position. The positioning system includes a conveyor mounting bracket. The conveyor mounting bracket is pivotably mounted to the tub and the conveyor. The positioning system includes an actuator for moving the conveyor between the stowed position, the conveying position, and the maintenance position. The actuator is able to move the conveyor between the stowed position and the conveying position by rotating the conveyor. The actuator is able to move the conveyor into the maintenance position by rotating the conveyor about two different axes.

Yet another aspect of the present disclosure is directed to a feed mixer for mixing material. The feed mixer includes a tub having a bottom and at least one sidewall. The at least one sidewall includes an outer surface and an inner surface. A discharge opening is located in the at least one sidewall. The inner surface and the bottom define a tub interior. A screw assembly is located in the tub interior. The screw assembly is rotatable. A conveyor assembly is pivotably located along the outer surface at the discharge opening. The screw assembly moves material towards the conveyor assembly as the screw assembly rotates. The conveyor assembly includes a conveyor and a positioning system that is configured to rotate the conveyor between a conveying state, a stowed state, and a maintenance state.

### BRIEF DESCRIPTION OF THE DRAWINGS

FIG. 1 is a perspective view of a vertical mixer of the present disclosure;

FIG. 2 is another perspective view of the vertical mixer of FIG. 1;

FIG. 3 is a top view of the vertical mixer;

FIG. 4 is a cutaway view of the vertical mixer of depicting the screw assembly located within the tub interior;

FIG. 5A is a perspective view of the mixer showing the discharge gate in an open position;

FIG. 5B is a perspective view of the mixer showing the discharge gate in a closed position;

FIG. 6 is a detailed exploded view of the conveyor assembly;

FIG. 7A depicts the linkage in the conveying state;

FIG. 7B depicts the linkage in the conveying state with a portion of the outer member removed;

FIG. 7C depicts the linkage in the maintenance state;

FIG. 7D depicts the linkage in the maintenance state with a portion of the outer member removed;

FIG. 8 is a rear view of the vertical mixer depicting the conveyor assembly in the conveying position;

FIG. 9 is a perspective view of the vertical mixer depicting the conveyor assembly in the conveying position;

FIG. 10 is a rear view of the vertical mixer depicting the conveyor assembly in the stowed position;

FIG. 11 is a perspective view of the vertical mixer depicting the conveyor assembly in the stowed position;

FIG. 12 is a rear view of the vertical mixer depicting the conveyor assembly in the maintenance position; and

FIG. 13 is a perspective view of the vertical mixer depicting the conveyor assembly in the maintenance position.

Corresponding reference characters indicate corresponding parts throughout the drawings.

### DETAILED DESCRIPTION

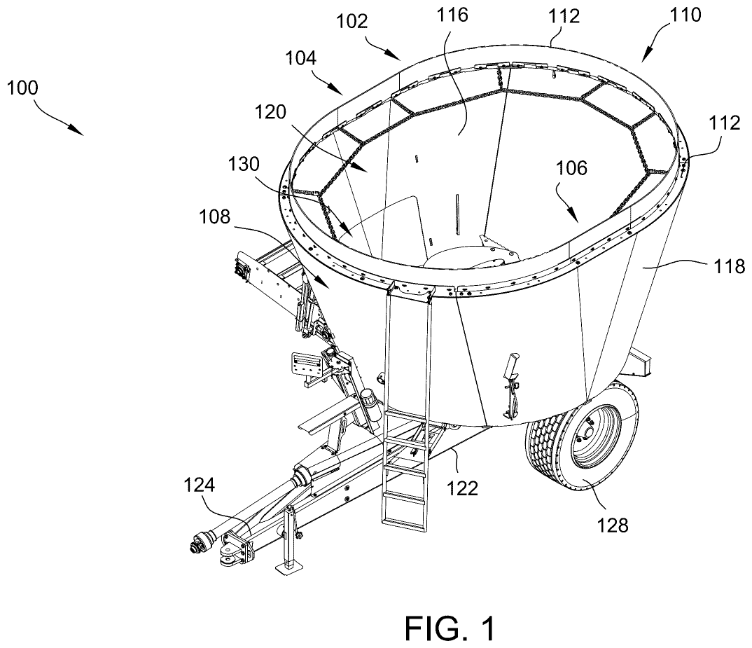

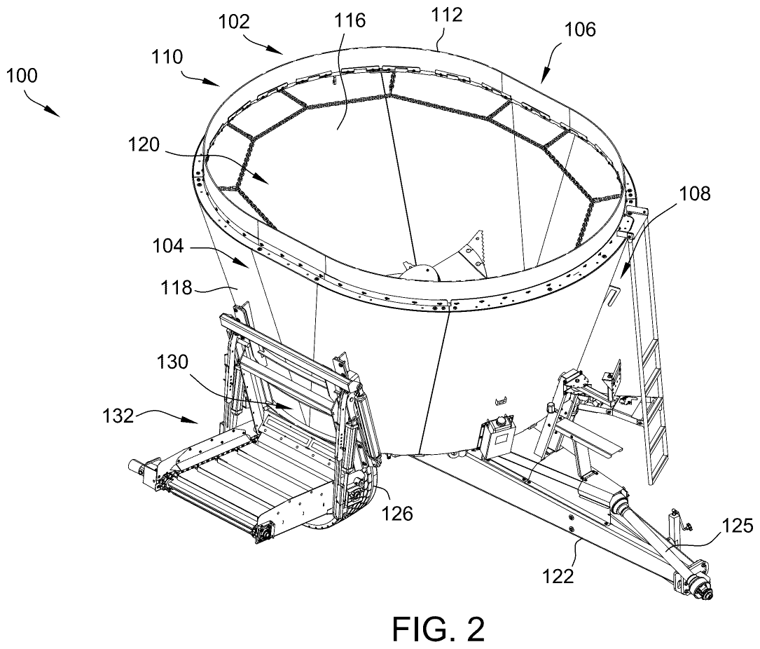

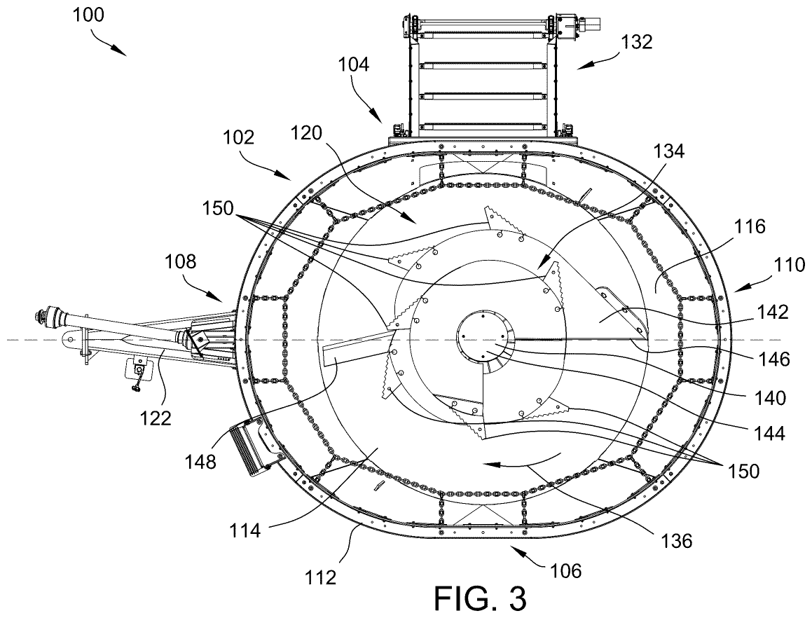

FIGS. 1 and 2 are perspective views of a vertical mixer 100 of the present disclosure. The vertical mixer 100 includes a tub 102, a screw assembly 134 (see FIG. 3) located in a tub interior 120, and a conveyor assembly 132 adjacent the exterior of the tub 102.

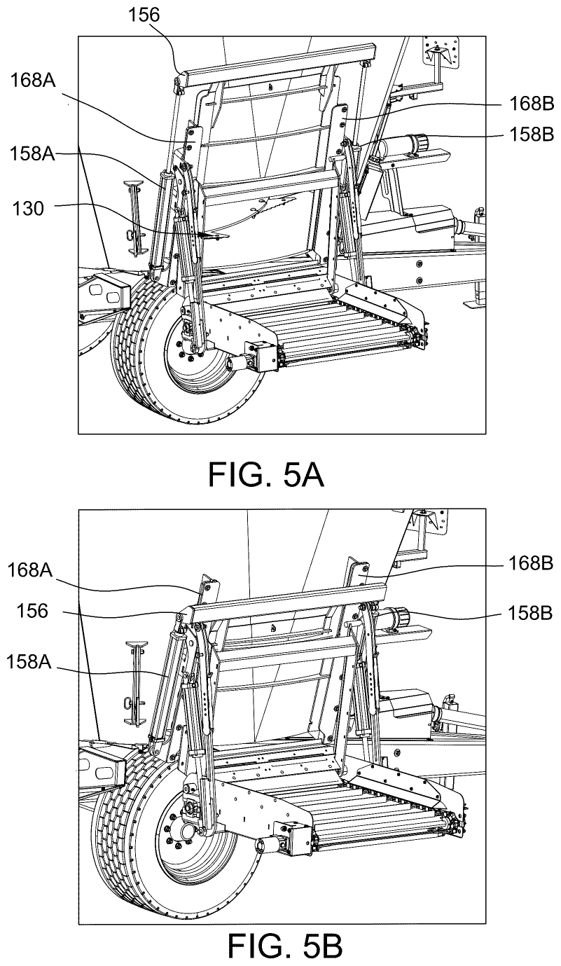

The tub 102 further includes a first side 104, a second side 106, a front side 108 and a rear side 110. The tub includes a sidewall 112 which extends upward around the perimeter of a bottom 114 (see FIG. 3) of the tub 102. The sidewall 112 includes an inner surface 116 and an outer surface 118. The inner surface 116 and the bottom 114 of the tub define the interior 120 of the tub 102. The vertical mixer 100 further includes a frame 122. The frame 122 includes a hitch attachment 124 for attachment of the vertical mixer 100 to a tractor (not shown). The frame 122 further includes a driveline 125. The driveline 125 is a portion of a drive system that transfers power from the tractor to the mixer, specifically rotational power to the screw assembly. The frame 122 is further attached to wheel assemblies 126, 128 (shown separately in FIG. 2 and FIG. 1 respectively). A discharge opening 130 is defined in the first side 104. The discharge opening 130 can be selectively opened or closed using a discharge gate 156 (See FIGS. 5A and 5B). The conveyor assembly 132 is mounted along the outer surface 118 of the first side 104 of tub 102 proximate the discharge opening 130.

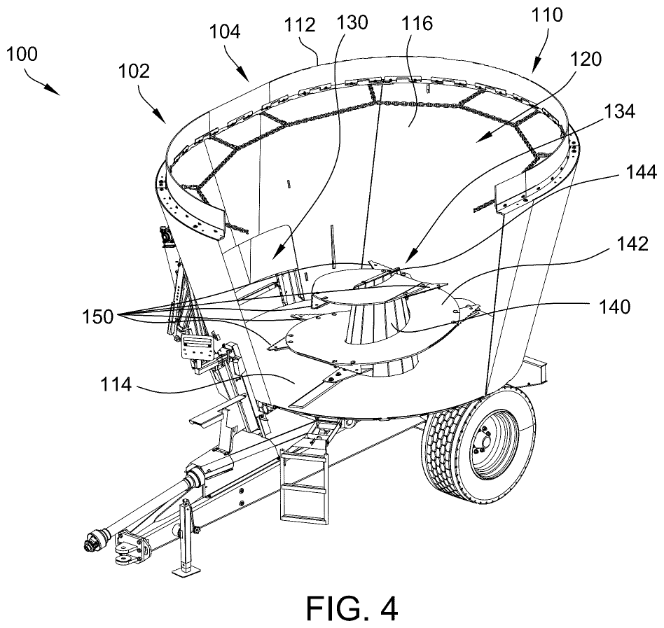

FIG. 3 is a top view of the vertical mixer 100. FIG. 4 is a cutaway view of the vertical mixer 100 depicting the screw assembly 134 located within the tub interior 120.

As shown in FIG. 3, the screw assembly 134 is located in the interior 120 of the tub 102. The screw assembly 134 includes a center post 140 that extends from the bottom 114 of the tub 102 toward the open top portion of the tub 102, a helical surface 142, and a plurality of blades 150. The center post 140 rotates in the direction of arrow 136 which in turn, rotates the screw assembly 134. In operation, feedstuffs are dumped into the interior 120 of the tub 102, and the rotation of the screw assembly 134, and blades 150 along the screw assembly (described below), chops the feedstuffs and mixes the feedstuffs with any desired additives, as well as directs the material towards the discharge opening 130 and conveyor assembly 132.

The helical surface 142 is connected to the center post 140 and extends radially outwardly from the center post 140. The helical surface 142 has a radial dimension that varies in magnitude along the helical surface 142 between the top and bottom portions of the helical surface 142. The helical surface 142 radial dimension magnitude is at a minimum value at a top end 144 of the center post 140 and increases in magnitude as the helical surface 142 spirals about the center post 140 towards a bottom (not shown) of the center post 140. The helical surface 142 radial dimension magnitude is at a maximum value at the bottom of the center post 140 proximate the tub bottom 114. Due to the construction of the helical surface 142 of the screw assembly 134 and the direction of rotation 136 of the screw assembly 134, as the screw assembly 134 rotates, material in the interior 120 is urged in an upward direction as it contacts the helical surface 142. The screw assembly 134 further includes a leading edge 146 and at least one cleanout leg 148. The leading edge 146 and the cleanout leg 148 contact the bottom 114 of the tub and move material collected along the bottom 114 towards the discharge opening 130.

The plurality of blades 150 is mounted to an outer peripheral edge 152 of the helical surface 142. The blades 150 are spaced apart along the outer peripheral edge 152 of the helical surface 142. In the illustrated embodiment, seven blades are shown, but in other embodiments, any suitable number of blades may be used. Each of the blades 150 has a serrated cutting edge.

FIG. 5A is a perspective view of the mixer 100 showing the discharge gate 156 in an open position. FIG. 5B is a perspective view of the mixer 100 showing the discharge gate 156 in a closed position. The discharge gate 156 is selectively opened when the material in the mixer 100 is fully mixed and ready to be discharged from the tub 102 via the conveyor assembly 132. The discharge gate 156 is moved up or down by a pair of discharge gate actuators 158A, 158B.

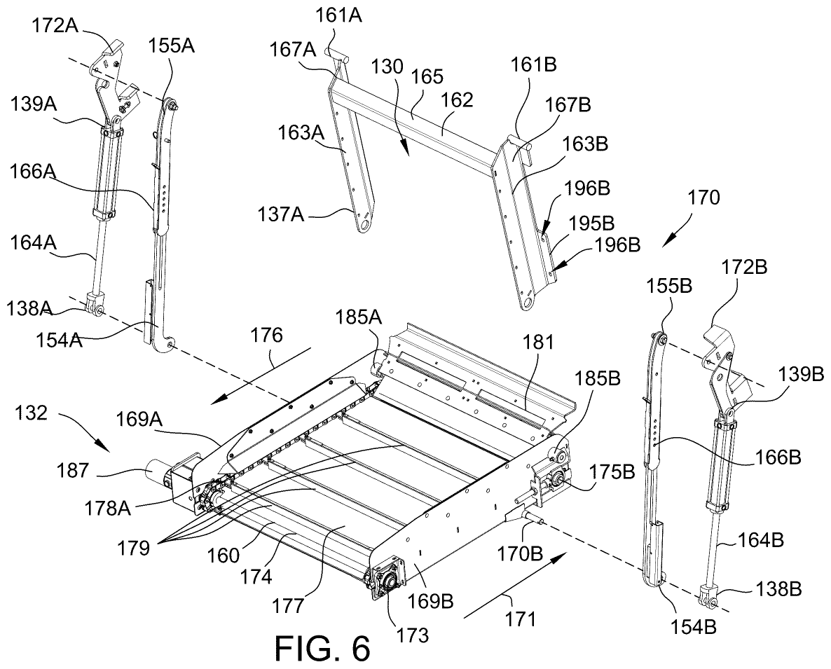

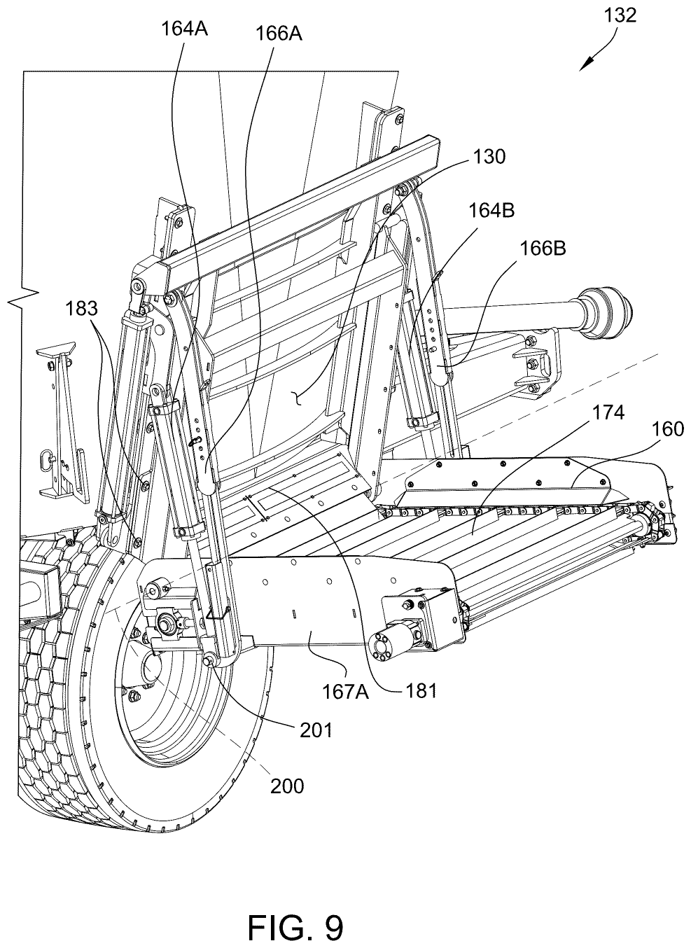

FIG. 6 is a detailed exploded view of the conveyor assembly 132 including a conveyor 160 and a conveyor positioning system 170. The conveyor positioning system 170 includes a conveyor mounting bracket 162, a pair of actuators 164A, 164B, each actuator 164A, 164B including a first end 138 and a second end 139, and a pair of linkages 166A, 166B, each linkage 166A, 166B including a first end 154A, 154B and a second end 155A, 155B. The conveyor 160 includes sides 169A, 169B. A pair of mounting supports 168A, 168B (see FIGS. 5A and 5B) are attached to the first side of the tub 102 on either side of the discharge opening 130. The pair of mounting supports 168A, 168B may include various brackets and apertures which allow for the mounting of the conveyor assembly 132. In some embodiments, the conveyor assembly 132 may be directly mounted to the outer surface 118 of the tub 102. The conveyor mounting bracket 162 includes a pair of arms 163A, 163B and a crossbar 165. Conveyor mounting bracket 162 further includes tabs 195A, 195B including apertures 196A, 196B. Fasteners such as threaded fasteners 183 (FIG. 9) may be inserted through the apertures 196A, 196B to securely fasten the tabs 195A, 195B to the mounting supports 168A, 168B.

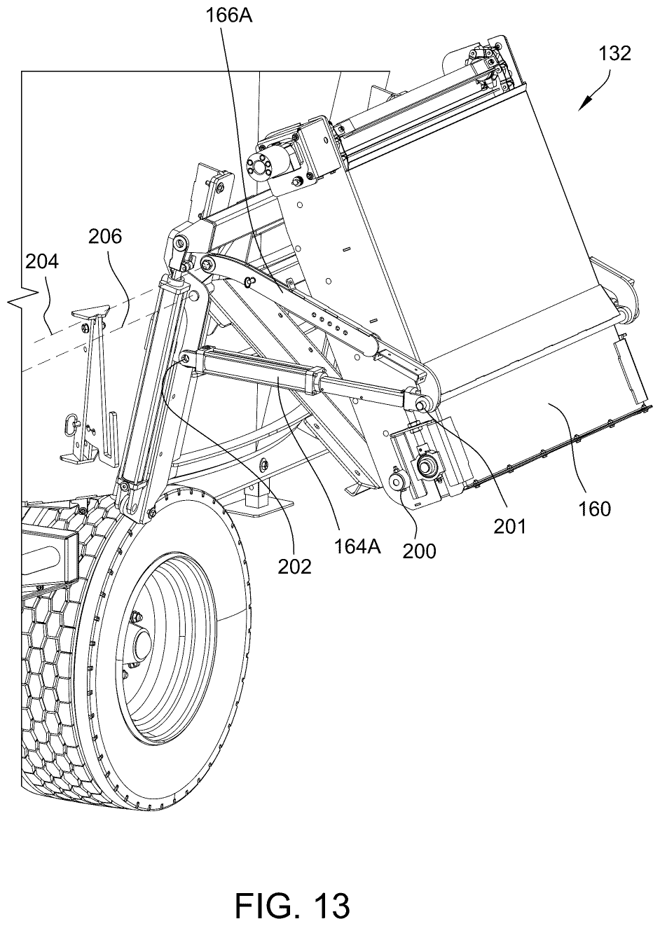

Each of the actuators 164A, 164B is pivotably attached by first ends 138A, 138B, at an attachment point 170A, 170B along each respective side 169A, 169B of the conveyor 160. Each of the actuators 164A, 164B is pivotably attached by second ends 139A, 139B to a bracket 172A, 172B at an attachment point (attachment point 202 shown in FIG. 13). The brackets 172A, 172B are attached to the respective mounting support 168A, 168B. The attachment may be by fasteners, welding, or any other suitable method of attachment.

Each of the linkages 166A, 166B is also pivotably attached by first ends 154A, 154B at the attachment point 170A, 170B along each respective side 169A, 169B of the conveyor 160. Each linkage 166A, 166B is pivotably attached by second ends 155A, 155B to the bracket 172A, 172B.

Each arm 163A, 163B of the conveyor mounting bracket 162 includes a first end 167A, 167B and a second end 137A, 137B. The first end 167A, 167B of each arm 163A, 163B is pivotably mounted to the respective mounting support 168A, 168B. The mounting support 168A, 168B includes a pivoting element 161A, 161B (e.g. an aperture, pin, or shaft) at ends 167A, 167B and apertures 196 for fastening elements 183 (FIG. 9) (e.g., threaded fasteners). The conveyor mounting bracket 162 is attached via the pivoting element 161A, 161B and fastening element 183 to the mounting supports 168A, 168B. The respective sides 169A, 169B of the conveyor 160 are pivotally attached to arms 163A, 163B at the second end 137A, 137B of each arm 163A, 163B by pins 185A, 185B.

The conveyor 160 further includes a conveying body 174, a first roller 173, a second roller 175, and an actuator 187. The conveying body 174, first roller 173, and second roller 175 extend between the conveyor sides 169A, 169B. In the present embodiment, the conveying body 174 further includes a floor 177 spanning between the first roller 173 and the second roller 175, and a pair of chains 178A, 178B having a plurality of bars 179 which span across the floor 177 between chains 178A-B. In operation, the chains 178A, 178B extend around the first roller 173 and the second roller 175 and travel in direction 176 as they move away from the tub 102 and then move in a direction 171 opposite direction 176 as they move toward the tub 102. In other embodiments, the conveying body 174 may be a belt, endless surface, or any other device which conveys material from the mixer 100. The illustrated actuator 187 is a rotary actuator, such as a hydraulic motor or electric motor, but in other embodiments, the actuator 187 may be any structure which enables the conveyor 160 to operate as described herein.

The conveyor 160 further includes a pan 181 mounted near the first roller 173. When in conveying position, as shown in FIG. 9, the pan 181 rests inside the discharge opening 130, spanning the lateral distance of the opening 130 and between conveyor sides 169A, 169B. The pan 181 also spans the distance between the interior 120 of the tub 102 and the conveyor 160. The pan 181 prevents the spillage and plugging of material as it is delivered from the tub interior 120 to the conveyor 160 through the opening 130. The pan 181 may be constructed from steel or any other suitable material, such as rubber, plastic, etc.

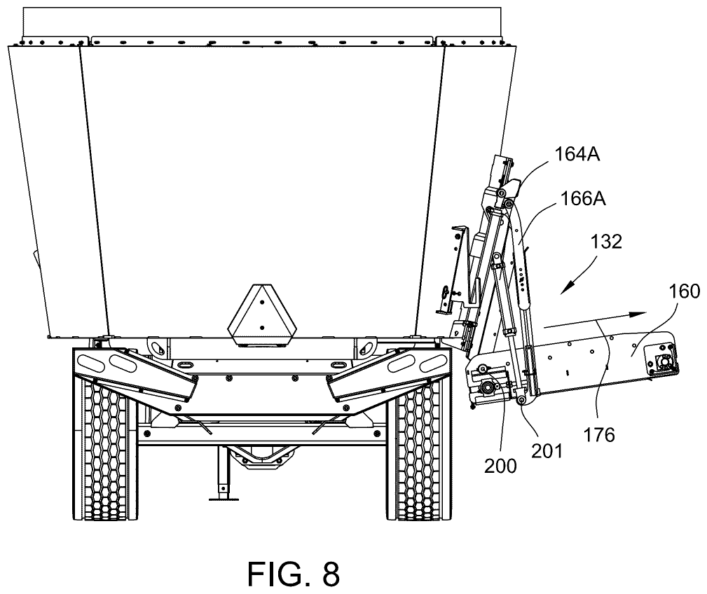

The conveyor 160 can be moved between conveying, stowed and maintenance positions (shown in FIGS. 8-13). The actuators 164A, 164B provide the controlled movement of the conveyor 160 between each position. As will be described further below, the linkages 166A, 166B serve to influence and limit the path of displacement of the conveyor 160.

Actuators 164A, 164B are hydraulic cylinders and move between an extended and retracted state. The actuators enable controlled movement of the conveyor 160 between the conveying, stowed and maintenance positions. In other embodiments, any type of actuator may be used to provide a force which moves the conveyor between the described positions.

As will be further described below, the linkages 166A, 166B limit the path of displacement and orientation of the conveyor 160 in the stowed, conveying and maintenance positions. Because the structure and functionality of the linkages 166A, 166B are substantially the same, for conciseness, as the description proceeds, reference will be made to linkage 166A. Unless otherwise indicated, the features and functionality described relative to linkage 166A apply to the linkage 166B.

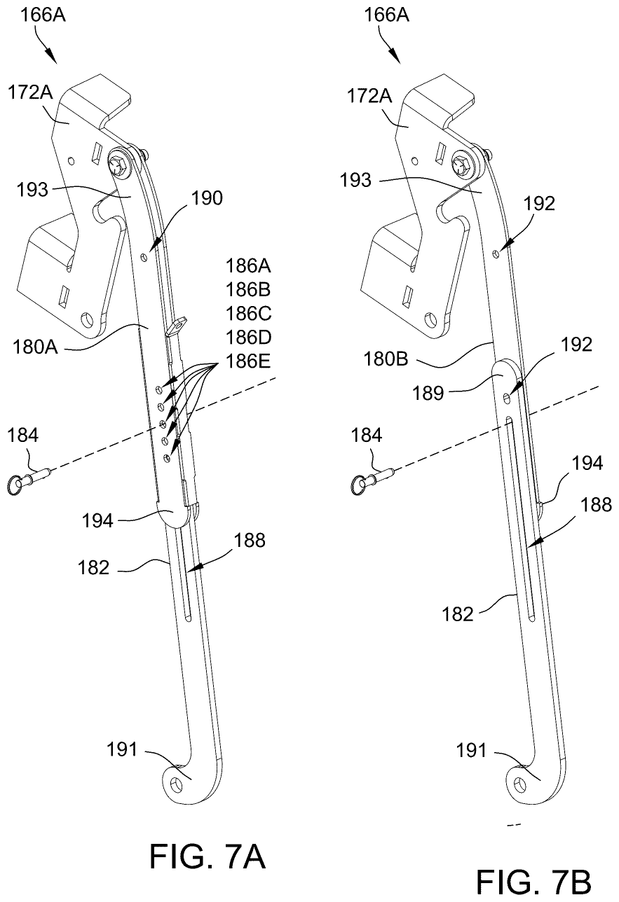

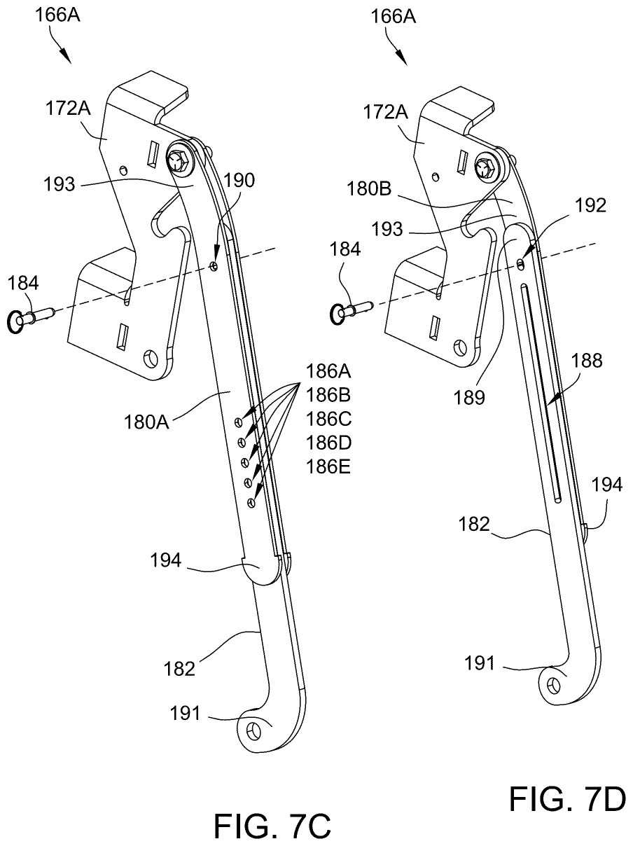

FIGS. 7A-7D depicts the linkage 166A oriented to enable the conveyor 160 to be located in the conveying state and the stowed state. Each linkage 166A, 166B consists of a pair of opposed outer members 180A, 180B, an inner member 182, and a pin 184. FIG. 7B depicts the linkage 166A of FIG. 7A with the outer member 180A not shown. The opposed members 180A, 180B are spaced apart and adapted to slidably receive the inner member 182 that is movable in the slot defined between the opposed outer members 180A, 180B. The inner member 182 includes an upper end 189, a lower end 191 that is movably fixed to the conveyor side 169A, a maintenance opening 192 proximate the upper end 189, and a slot 188 that extends along the length of the inner member 182 between maintenance opening 192 and lower end 191.

Each outer member 180A, 180B has a first end 193 and a second end 194. Additionally, each member 180A, 180B includes a maintenance opening 190, near the respective first end 193. A plurality of spaced apart conveyor height selection openings 186A, 186B, 186C, 186D and 186E are provided along the length of each outer member between the respective maintenance opening 190 and second end 194. Openings 190 and 186A-E are adapted to receive the removable pin 184.

When the pin 184 is inserted into one of the conveyor height selection openings 186A-E of the outer member 180 and the slot 188 of the inner member 182, the linkage 166A is in an unlocked state. In the unlocked state, the inner member 182 is slidable relative to the outer members 180A, 180B. The height of the discharge end of conveyor 160 can be adjusted by adjusting the location of the pin 184 in the conveyor height selection openings 186A-E.

FIGS. 7A, 7B show a position of outer members 180A, 180B and inner member 182 of linkage 166A in a position where the actuators 164A, 164B are able to move the conveyor to the conveying or stowed positions. FIGS. 7C, 7D show a position of outer members 180A, 180B and inner member 182 of linkage 166A in a position where the actuators 164A, 164B are able to move the conveyor to the maintenance position.

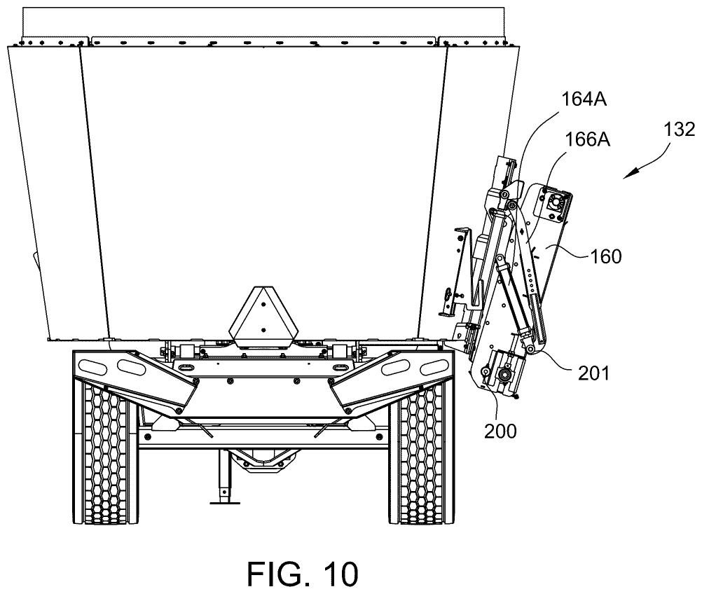

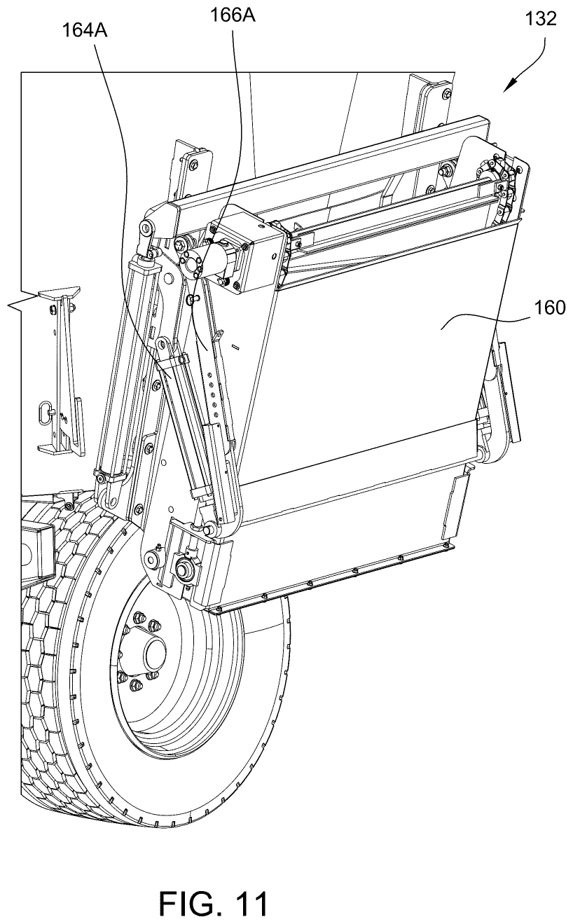

Referring to FIGS. 7A and 7B, when the conveyor 160 is movable to the stowed position (shown in FIGS. 10 and 11), the pin 184 is inserted through one of the conveyor height selection openings 186A-E of the outer member 180A, through the slot 188, and through the corresponding height selection opening 186A-E in outer member 180B. When moving the conveyor 160 from the stowed position and into the conveying position, the actuators 164A, 164B extend, and the inner member 182 of the linkages 166A, 166B slides between the outer members 180A, 180B. Once the linkage 166A is positioned such that the pin 184 is at the end of travel at the closed top of the slot 188 (see FIG. 7B), the conveyor 160 is in the conveying state.

FIG. 7C depicts the linkage 166A in the maintenance state. FIG. 7D depicts the linkage 166A in the maintenance position with the outer member 180A not shown. In the maintenance position, the first maintenance position opening 190 is aligned with the second maintenance position opening 192. The pin 184 is inserted through the first maintenance position opening 190 and the second maintenance position opening 192 which places the linkage 166A into a locked state. In the locked state, the outer member 180 and the inner member 182 are not allowed to slide relative to each other.

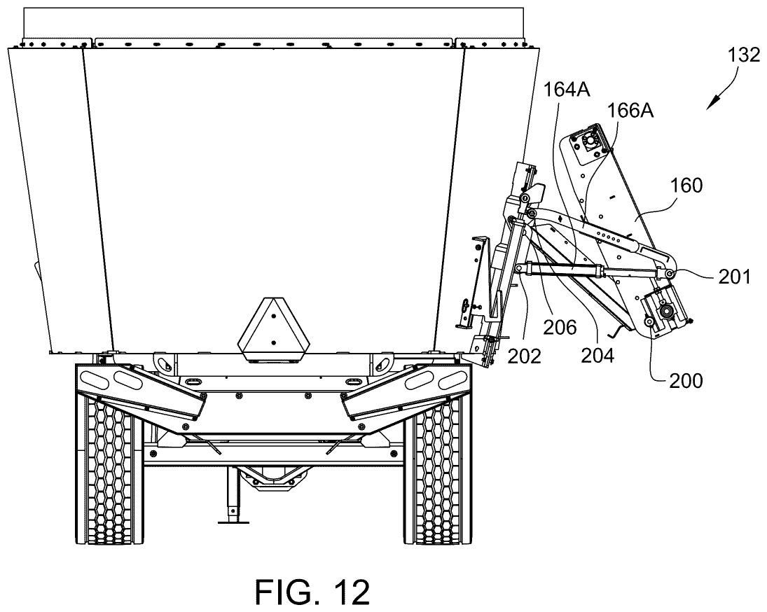

When the conveyor 160 is located in the conveying position (shown in FIGS. 8 and 9), the conveyor 160 extends outwardly from and substantially perpendicular to the tub 102, and the pin 184 extends through corresponding conveyor height selection openings 186A-E and slot 188. In the stowed position (shown in FIGS. 10 and 11), the conveyor 160 is located adjacent the outer surface 118 of the first side 104, and the pin 184 is located in corresponding conveyor height selection openings 186A-E and through slot 188. When the conveyor 160 is in the maintenance position (shown in FIGS. 12 and 13), the pin 184 extends through maintenance openings 190 and 192. In the maintenance position, the pin 184 does not extend through slot 188. As shown in FIGS. 12 and 13, when in the maintenance position, the conveyor 160 is located away from the tub 102 and above the wheel assembly 126 to enable and facilitate maintenance to the frame and tires.

FIGS. 8 and 9 are rear and perspective views of the vertical mixer 100 depicting the conveyor assembly 132 in the conveying position. In the conveying position, the conveyor 160 extends out from the vertical mixer 100, and the conveying body 174 moves in direction 176 to discharge contents of the mixer 100 out of the tub 102. To move into the conveying position from the stowed position, the actuators 164A, 164B are extended and the linkages 166A, 166B are in an unlocked state. As the conveyor 160 is moved into the conveying position by actuators 164A, 164B from the stowed position, the conveyor 160 rotates about a first axis 200 which allows the discharge end of conveyor 160 to rotate away from the mixer 100. First axis 200 is coaxial in reference to pins 185A, 185B.

FIGS. 10 and 11 are rear and perspective views of the vertical mixer 100 depicting the conveyor assembly 132 in a stowed position. In the stowed position, the conveyor 160 is folded up against the first side 104 such that the conveyor is parallel with the first side 104. To move into the stowed position from the conveying position, the actuators 164A, 164B are retracted and the linkages are in an unlocked state. Similarly as described above with regard to the conveying state, the conveyor 160 is pivoted about the first axis 200 to move the conveyor 160 into the stowed state.

FIGS. 12 and 13 are rear views of the vertical mixer 100 depicting the conveyor assembly 132 in the maintenance position. In the maintenance position, the conveyor 160 remains folded, as in the stowed position, however, the conveyor 160 is pivoted upwards and away from the tub 102 and located above the frame 122 and wheel assembly 126. To move into the maintenance position from the stowed position, the fasteners 183 that secure arms 163A, 163B of the conveyor mounting bracket 162 to the mounting supports 168A, 168B) are removed, the linkages 166A, 166B are moved to the locked state, and the actuators 164A, 164B are extended.

As the conveyor 160 is rotated into the maintenance position, there may also be a rotation of the conveyor 160 about the first axis 200 and a second axis 201. Second axis 201 is coaxial in reference to attachment point 170A, 170B and is the pivotal point of connection of the actuators 164A, 164B and linkages 166A, 166B. As the actuators 164A, 164B extend and facilitate displacement of the conveyor, the conveyor 160 rotates about a third axis 204 (coaxial with a line that extends between the connection points of the linkages 166A, 166B to the brackets 172A, 172B) and a fourth axis 206. The fourth axis 206 is defined by the line that extends between the attachment point of the arms 163A, 163B of the conveyor mounting bracket 162 to the mounting supports 168A, 168B. The fourth axis 206 can also be defined as being coaxial with pivoting elements 161A, 161B (e.g., pins) (see FIG. 6). As shown in FIG. 12, at least one (and both as in the illustrated embodiment) of the third axis 204 and fourth axis 206 are disposed above the first axis 200. Retraction of the actuators 164A, 164B causes the conveyor 160 to move back to the stowed position.

The rotation of the conveyor 160 into the maintenance position raises the conveyor 160 above a plane of the bottom 114 of the tub 102. This compound rotation is enabled at least by the locked linkages 166A, 166B as a result of the pin 184 located in maintenance openings 190, 192. This allows for access to the frame 122 and the wheel assembly 126. The increased access to the wheel assembly 126 allows for a more rugged design which incorporates a larger wheel assembly than may otherwise be achieved.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing [s] shall be interpreted as illustrative and not in a limiting sense.

What is claimed is:

1. A feed mixer for mixing material, the feed mixer comprising:
a tub comprising a bottom and at least one sidewall, the at least one sidewall comprising an outer surface and an inner surface, a discharge opening located in the at least one sidewall, the inner surface and the bottom defining a tub interior;
a screw assembly located in the tub interior, the screw assembly being rotatable;
a conveyor assembly pivotably located along the outer surface at the discharge opening, wherein the screw assembly moves material towards the conveyor assembly as the screw assembly rotates, the conveyor assembly comprising:
a conveyor mounting bracket pivotably mounted to the tub;
a linkage pivotally mounted to the tub;
a conveyor pivotally mounted to the conveyor mounting bracket and pivotally mounted to the linkage; and
an actuator for moving the conveyor between a stowed position and a maintenance position.

2. The feed mixer of claim 1, wherein the linkage is adjustable between a locked state and an unlocked state.

3. The feed mixer of claim 2, wherein when the linkage is in the unlocked state the actuator is able to move the conveyor between the stowed position and a conveying position.

4. The feed mixer of claim 3, wherein the conveyor is pivotally mounted to the conveyor mounting bracket at a first axis, the conveyor rotating about the first axis to move between the stowed position and the conveying position.

5. The feed mixer of claim 1, wherein the conveyor is pivotally mounted to the conveyor mounting bracket at a first axis, the conveyor is pivotally mounted to the linkage at a second axis, the linkage is pivotally mounted to the tub at a third axis, and the conveyor mounting bracket is pivotally mounted to the tub at a fourth axis, wherein the conveyor rotates about the third axis and the fourth axis to move into the maintenance position from the stowed position.

6. The feed mixer of claim 5, wherein at least one of the third axis and the fourth axis is located above the first axis.

7. The feed mixer of claim 5, wherein the linkage is adjustable between a locked state and an unlocked state, and when the linkage is in the locked state the actuator is able to move the conveyor into the maintenance position.

8. The feed mixer of claim 3, wherein the conveyor mounting bracket is secured to the tub in the conveying position.

9. The feed mixer of claim 8, wherein the conveyor mounting bracket is secured to the tub by threaded fasteners in the conveying position.

10. The feed mixer of claim 1, wherein when the conveyor is in the maintenance position, the conveyor is above a plane defined by the bottom of the tub.

11. The feed mixer of claim 1, wherein the conveyor assembly is located above a wheel assembly of the feed mixer.

12. The feed mixer of claim 11, wherein the maintenance position permits access to the wheel assembly.

13. A feed mixer for mixing material, the feed mixer comprising:
a tub comprising a bottom and at least one sidewall, the at least one sidewall comprising an outer surface and an inner surface, a discharge opening located in the at least one sidewall, the inner surface and the bottom defining a tub interior;
a screw assembly located in the tub interior, the screw assembly being rotatable;
a conveyor assembly pivotably located along the outer surface at the discharge opening, wherein the screw assembly moves material towards the conveyor assembly as the screw assembly rotates, the conveyor assembly comprising:
a conveyor; and
a positioning system configured to rotate the conveyor between a stowed position, a conveying position, and a maintenance position, wherein the positioning system includes:
a conveyor mounting bracket, wherein the conveyor mounting bracket is pivotably mounted to the tub and the conveyor; and
an actuator for moving the conveyor between the stowed position, the conveying position, and the maintenance position,
wherein the actuator is able to move the conveyor between the stowed position and the conveying position by rotating the conveyor, and
wherein the actuator is able to move the conveyor into the maintenance position by rotating the conveyor about two different axes.

14. The feed mixer of claim 13, wherein the conveyor assembly further includes:
a linkage adjustable between a locked state and an unlocked state,
wherein when the linkage is in the unlocked state the actuator is able to move the conveyor between the stowed position and the conveying position; and
wherein when the linkage is in the locked state the actuator is able to move the conveyor into the maintenance position by rotating the conveyor.

15. The feed mixer of claim 14, wherein the linkage comprises an outer member and an inner member, wherein when the linkage is in the unlocked state, the inner member slides within the outer member, and wherein when the linkage is in the locked state, the inner member is not slidable within the outer member.

16. The feed mixer of claim 13, wherein the maintenance position rotates the conveyor such that the conveyor is moved above a plane defined by the bottom of the tub.

17. The feed mixer of claim 13, wherein the conveyor assembly is located above a wheel assembly of the feed mixer.

18. The feed mixer of claim 14, wherein the maintenance position permits access to a wheel assembly.

19. A feed mixer for mixing material, the feed mixer comprising:
a tub comprising a bottom and at least one sidewall, the at least one sidewall comprising an outer surface and an inner surface, a discharge opening located in the at least one sidewall, the inner surface and the bottom defining a tub interior;
a screw assembly located in the tub interior, the screw assembly being rotatable;
a conveyor assembly pivotably located along the outer surface at the discharge opening, wherein the screw assembly moves material towards the conveyor assembly as the screw assembly rotates, the conveyor assembly comprising:
a conveyor; and
a positioning system configured to rotate the conveyor between a conveying state, a stowed state, and a maintenance state.
